(19) United States
(12) Patent Application Publication
(10) Pub. No.: US 2019/0213808 A1
(43) Pub. Date: Jul. 11, 2019

(54) VEHICLE HEALTH AND MAINTENANCE COST ESTIMATIONS BASED ON AUTOMOBILE OPERATION

(71) Applicant: International Business Machines Corporation, Armonk, NY (US)

(72) Inventors: Schayne Bellrose, Poughkeepsie, NY (US); Ali Y. Duale, Poughkeepsie, NY (US); Eric R. Eastman, Lagrangeville, NY (US); Heidi Lagares-Greenblatt, Jefferson Hills, PA (US); Jang H. Sim, Dutchess, NY (US)

(21) Appl. No.: 15/862,778

(22) Filed: Jan. 5, 2018

(51) Int. Cl. G07C 5/08; G07C 5/00; B60W 40/09

(52) U.S. Cl. CPC G07C 5/0816; G07C 5/0808; B60W 2540/30; B60W 40/09; G07C 5/006; G07C 5/008

(57) ABSTRACT

Embodiments include methods, systems and computer program products method for monitoring a life cycle of one or more parts for an automobile and providing suggestions for maintenance of the automobile. The computer-implemented method includes monitoring, using a processor, a plurality of parts of an automobile. The processor compares a health state associated with each of the plurality of parts to a health threshold associated with each of the plurality of parts. The processor further predicts a health life for each of the plurality of parts based on the comparison for each of the plurality of parts. The processor provides an alert to a driver in response to a least one part of the plurality of parts exceeding an associated health threshold. The processor further provides at least one cost estimate for repair, replacement or maintenance of the at least one part to the driver.

### BACKGROUND

The present invention relates in general to vehicle maintenance and more specifically, to vehicle maintenance estimations and costs associated with automobile operations.

To ensure safe operations of a vehicle, vehicle maintenance is necessary to maintain a proper working order for the vehicle. Proper, routine car maintenance is vital to avoid major repair bills and keeping a vehicle running reliably for many years. For individuals unfamiliar with vehicle maintenance, diagnosing problems or potential problems for a given part or parts can be intimidating. Moreover, understanding costs for car maintenance can be difficult because estimates between mechanics can vary wildly.

### SUMMARY

Embodiments of the invention are directed to a method for monitoring a life cycle of one or more parts for an automobile and providing suggestions for maintenance of the automobile. A non-limiting example of the computer-implemented method includes monitoring, using a processor, a plurality of parts of an automobile. The processor compares a health state associated with each of the plurality of parts to a health threshold associated with each of the plurality of parts. The processor further predicts a health life for each of the plurality of parts based on the comparison for each of the plurality of parts. The processor provides an alert to a driver in response to a least one part of the plurality of parts exceeding an associated health threshold. The processor further provides at least one cost estimate for repair, replacement or maintenance of the at least one part to the driver.

Embodiments of the invention are directed to a computer program product that can include a storage medium readable by a processing circuit that can store instructions for execution by the processing circuit for performing a method for monitoring a life cycle of one or more parts for an automobile and providing suggestions for maintenance of the automobile. The method includes monitoring a plurality of parts of an automobile. The processor compares a health state associated with each of the plurality of parts to a health threshold associated with each of the plurality of parts. The processor further predicts a health life for each of the plurality of parts based on the comparison for each of the plurality of parts. The processor provides an alert to a driver in response to a least one part of the plurality of parts exceeding an associated health threshold. The processor further provides at least one cost estimate for repair, replacement or maintenance of the at least one part to the driver.

Embodiments of the invention are directed to a system. The system can include a processor in communication with one or more types of memory. The processor can be configured to monitor a plurality of parts of an automobile. The processor can be configured to compare a health state associated with each of the plurality of parts to a health threshold associated with each of the plurality of parts. The processor can be configured to predict a health life for each of the plurality of parts based on the comparison for each of the plurality of parts. The processor can be configured to provide an alert to a driver in response to a least one part of the plurality of parts exceeding an associated health threshold. The processor can be configured to provide at least one cost estimate for repair, replacement or maintenance of the at least one part to the driver.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The forgoing and other features, and advantages of the disclosure are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a block diagram illustrating one example of a processing system for practice of the teachings herein;

FIG. 4 is a block diagram illustrating a computing system according to one or more embodiments of the present invention; and

FIG. 5 is a flow diagram of a method for monitoring a life cycle of one or more parts of an automobile and providing suggestions for maintenance of the automobile according to one or more embodiments of the present invention.

The diagrams depicted herein are illustrative. There can be many variations to the diagram or the operations described therein without departing from the spirit of the invention. For instance, the actions can be performed in a differing order or actions can be added, deleted, or modified. In addition, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments of the invention, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, embodiments of the invention are related in general to vehicle maintenance and upkeep. Safety for a car owner and individuals within a range of the vehicle is largely due to the vehicle operating in manner envisioned by a vehicle manufacturer. Vehicle manufacturers intend for parts of the vehicle to be replaced and/or receive maintenance after the vehicle incurs a predetermined amount of wear and tear. However, car owners often fail to realize that parts should be replaced or maintained. When car owners do recognize that parts should be replaced or maintained, they often have no understanding of which parts should be replaced or the costs associated with replacing parts or needed maintenance.

Turning now to an overview of the aspects of the invention, one or more embodiments of the invention address the above-described shortcomings of the prior art by using a maintenance prediction engine that can predict a life cycle of vehicle parts for an automobile based on driving habits for one or more drivers associated with the automobile. Based on the predicted maintenance for the vehicle, drivers can be more informed of parts that need replacement or maintenance, as well as costs associated with such replacement or maintenance.

The above-described aspects of the invention address the shortcomings of the prior art by causing a driver to be more informed of parts of a vehicle that may need replacement or maintenance in consideration of driving habits associated with the driver, as well as costs associated with the maintaining the driver's vehicle. The invention can also provide cost information to the driver based on location information associated with the driver and provide maintenance predictions for parts related to the parts initially suggested for replacement or maintenance in which efficiencies may be gained if the set of parts are replaced or maintained together.

It is understood in advance that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud-computing environment is service oriented with a focus on statelessness, low coupling, modularity, and semantic interoperability. At the heart of cloud computing is an infrastructure comprising a network of interconnected nodes.

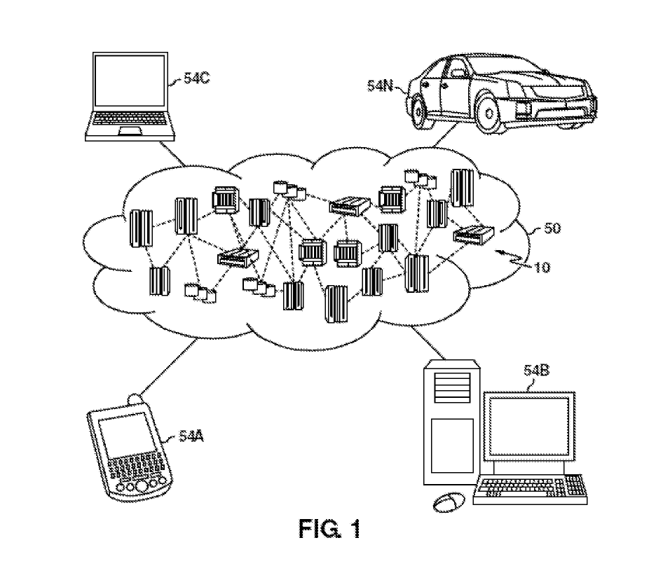

Referring now to FIG. 1, illustrative cloud computing environment 50 is depicted. As shown, cloud-computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud-computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

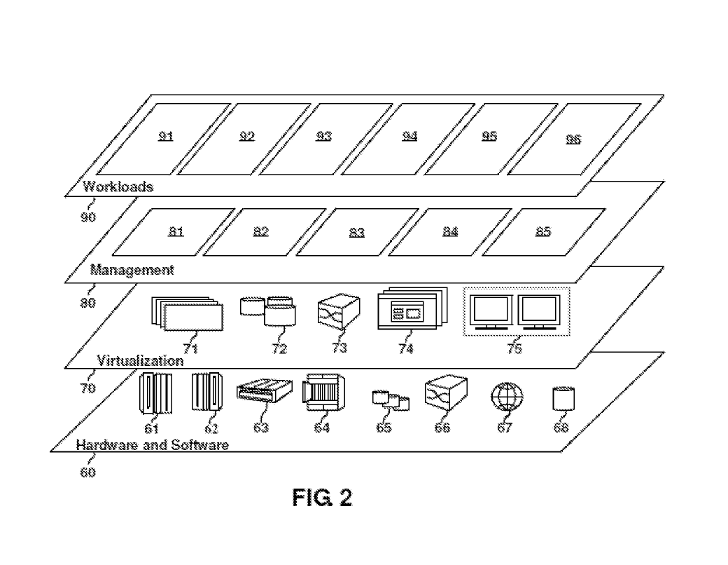

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud-computing environment. Metering and Pricing 82 provide cost tracking as resources are utilized within the cloud-computing environment, and billing or invoicing for consumption of these resources. In one example, these resources may comprise application software licenses. Security provides identity verification for cloud consumers and tasks, as well as protection for data and other resources. User portal 83 provides access to the cloud-computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud-computing environment may be utilized. Examples of workloads and functions that may be provided from this layer include: mapping and navigation 91; software development and lifecycle management 92; virtual classroom education delivery 93; data analytics processing 94; transaction processing 95; and monitoring a life cycle of one or more parts for an automobile and providing suggestions for maintenance 96.

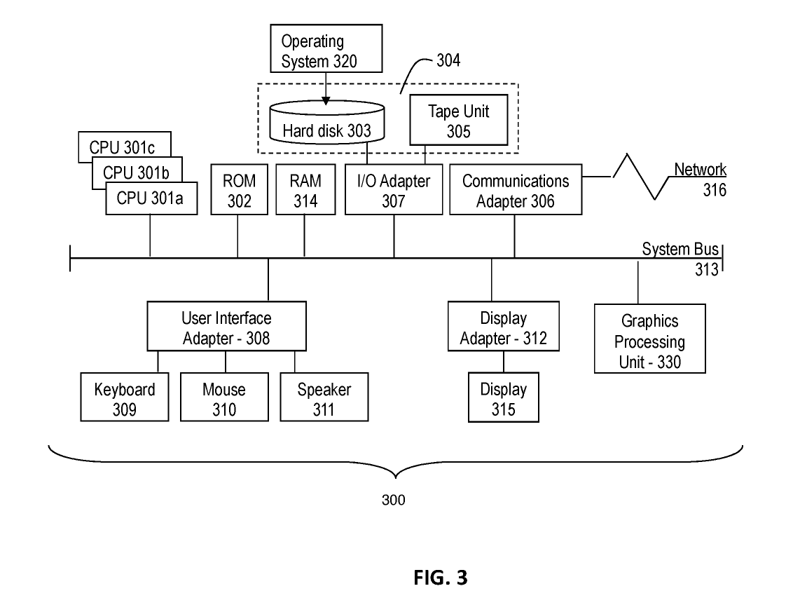

Referring to FIG. 3, there is shown a processing system 300 for implementing the teachings of the present disclosure according to one or more embodiments of the invention described herein. The system 300 has one or more central processing units (processors) 301a, 301b, 301c, etc. (collectively or generically referred to as processor(s) 301). In one embodiment, each processor 301 may include a reduced instruction set computer (RISC) microprocessor. Processors 301 are coupled to system memory 314 and various other components via a system bus 313. Read only memory (ROM) 302 is coupled to the system bus 313 and may include a basic input/output system (BIOS), which controls certain basic functions of system 300.

FIG. 3 further depicts an input/output (I/O) adapter 307 and a communications adapter 306 coupled to the system bus 313. I/O adapter 307 may be a small computer system interface (SCSI) adapter that communicates with a hard disk 303 and/or tape storage drive 305 or any other similar component. I/O adapter 307, hard disk 303, and tape storage device 305 are collectively referred to herein as mass storage 304. Operating system 320 for execution on the processing system 300 may be stored in mass storage 304. A communications adapter 306 interconnects bus 313 with an outside network 316 enabling data processing system 300 to communicate with other such systems. A screen (e.g., a display monitor) 315 is connected to system bus 313 by display adapter 312, which may include a graphics adapter to improve the performance of graphics intensive applications and a video controller. In one embodiment, adapters 307, 306, and 312 may be connected to one or more I/O busses that are connected to system bus 313 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 313 via user interface adapter 308 and display adapter 312. A keyboard 309, mouse 310, and speaker 311 all interconnect to bus 313 via user interface adapter 308, which may include, for example, a Super I/O chip integrating multiple device adapters into a single integrated circuit.

In exemplary embodiments of the invention, the processing system 300 includes a graphics-processing unit 330. Graphics processing unit 330 is a specialized electronic circuit designed to manipulate and alter memory to accelerate the creation of images in a frame buffer intended for output to a display. In general, graphics-processing unit 330 is very efficient at manipulating computer graphics and image processing, and has a highly parallel structure that makes it more effective than general-purpose CPUs for algorithms where processing of large blocks of data is done in parallel.

Thus, as configured in FIG. 3, the processing system 300 includes processing capability in the form of processors 301, storage capability including system memory 314 and mass storage 304, input means such as keyboard 309 and mouse 310, and output capability including speaker 311 and display 315. In one embodiment, a portion of system memory 314 and mass storage 304 collectively store an operating system such as the AIX® operating system from IBM Corporation to coordinate the functions of the various components shown in FIG. 3.

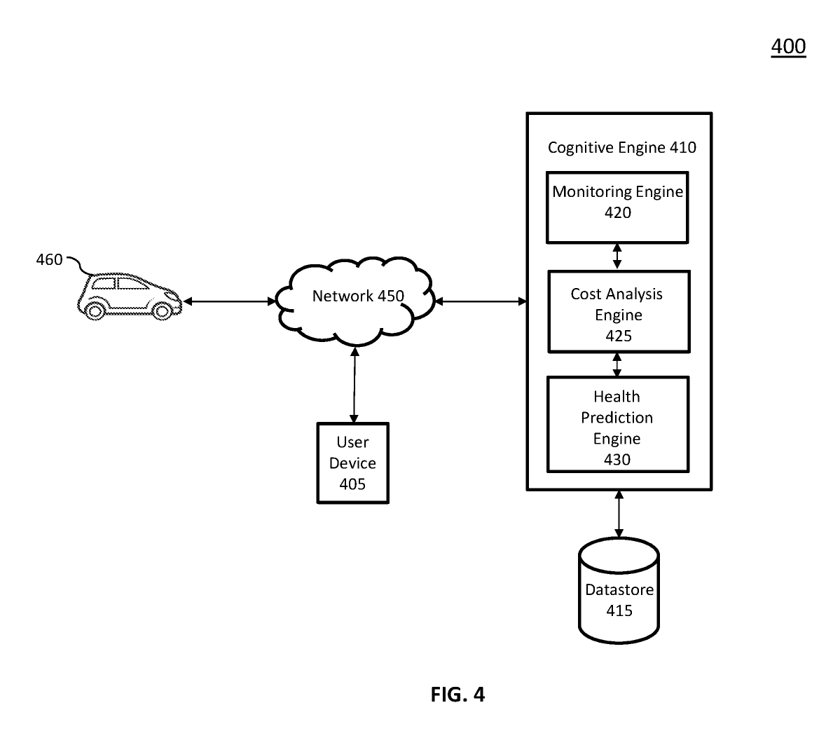

Referring now to FIG. 4, there is illustrated a computing system 400 in accordance with one or more embodiments of the invention. As illustrated, the computing system 400 can include but is not limited to, an automobile 460, a user device 405, a maintenance prediction engine 410 and a datastore 415 connected over one or more networks, for example, network 450. The automobile 460, user device 405, and maintenance prediction engine 410 can utilize processing system 300 (FIG. 3). In some embodiments of the invention, the maintenance prediction engine 410 can include a monitoring engine 420, cost analysis engine 425, and a health prediction engine 430.

In some embodiments of the invention, the user device 405 can be any type of computing device, such as a computer, laptop, tablet, smartphone, wearable computing device, server, etc. The user device 405 can include one or more applications, such as a web browser that can communicate with the maintenance prediction engine 410 over one or more networks 450.

The network(s) 450 can include, but are not limited to, any one or a combination of different types of suitable communications networks such as, for example, cable networks, public networks (e.g., the Internet), private networks, wireless networks, cellular networks, or any other suitable private and/or public networks. Further, the network(s) 450 can have any suitable communication range associated therewith and can include, for example, global networks (e.g., the Internet), metropolitan area networks (MANs), wide area networks (WANs), local area networks (LANs), or personal area networks (PANs). In addition, the network(s) 450 can include any type of medium over which network traffic can be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

In some embodiments, the maintenance prediction engine 410 can be any type of computing device with network access, such as a computer, laptop, server, tablet, smartphone, wearable computing devices, or the like. The maintenance prediction engine 410 can be part of a cloud-computing environment (FIG. 1) that provides a specific functionality to the user device 405, such as a software-as-a-service functionality.

The monitoring engine 420 can include computer-readable instructions that, in response to execution by the processor(s) 301, cause operations to be performed including monitoring wear and tear for a plurality of parts used to operate automobile 460 and driving habits for a driver associated with automobile 460. The monitoring engine 420 can use one or more sensors (e.g., brake sensors, oil pressure, temperature, etc.) associated with automobile 460 to monitor the wear and tear of parts for automobile 460 and driving habits associated with the driver of automobile 460. The monitoring engine 420 may also monitor location information, routing information, and weather information associated with automobile 460. The monitoring engine 420 can also facilitate a transmission of data to the datastore 415.

The datastore 415 can store data associated with wear and tear of automobile 460, as well as wear and tear data for a plurality of automobiles. The datastore 415 can store nominal information data associated with a plurality of vehicles. The nominal information can be associated with manufacturer specifications regarding parts used in the operation of a plurality of different types of automobiles. The nominal information may be used to group parts of automobile 460 that can be maintained together. The datastore 415 can also store location information and cost estimates (e.g., average replacement or maintenance costs for a given part in a given location) for replacement and maintenance of a plurality of parts.

The cost analysis engine 425 may include computer-readable instructions that, in response to execution by the processor(s) 301, cause operations to be performed including calculating repair estimates to replace or maintain parts based on, for example, a geographic location associated with a driver of automobile 460. For example, the cost analysis engine 425 can determine an average cost of repair for a recommended part within a predetermined radius associated with the driver. The cost analysis engine 425 can also determine maintenance cost patterns associated with a given part and/or location.

The health prediction generator 430 may include computer-readable instructions that, in response to execution by the processor(s) 301, cause operations to be performed, including generating cost estimates for parts recommended for replacement and/or maintenance based on a location associated with a driver. The health prediction generator 430 can obtain wear and tear information and driving habit information from the monitoring engine 420 and/or datastore 415 in order to estimate a life cycle for one or more vehicle parts of automobile 460. The health prediction generator 430 can notify a driver via automobile 460 or user device 405 that the one or more parts are at or near an end of life. For example, a life expectancy for one or more parts (i.e. 50%, 80%, 100%, etc.) can be communicated to a driver to alert the driver of issues related to maintenance for automobile 460.

The health prediction generator 430 may analyze wear and tear information (for a driver or multiple drivers), driving habit information (for a driver or multiple drivers), location information, routing information and weather information from the monitoring engine 420 to determine patterns/behaviors that affect a life cycle (reduce or improve) for one or more parts related to automobile 460. The health prediction generator 430 may use the determined patterns/behaviors to provide drivers with suggestions on how to extend the life cycle of one or more parts related to automobile 460. For example, the health prediction generator 430 may inform the driver, via a console within the automobile 460 or a display on a user device 405, that his/her driving habits wear the brakes faster than an average driver wears brakes.

The health prediction generator 430 may additionally analyze cost information obtained from the cost analysis engine 425 in conjunction with the wear and tear information (for a driver and other drivers), driving habit information (for a driver and other drivers), location information, routing information and weather information from the monitoring engine 420 to determine and indicate which parts should be replaced or receive maintenance and provide cost estimates for the replacement or maintenance of the parts. The associated cost estimates can be based on a location or predetermined radius associated with the location for automobile 460.

In addition, the health prediction generator 430 may also provide suggestions and cost estimates related to replacing or maintaining parts additional to the one or more parts that were previously suggested for replacement or maintenance that have been associated with the previously suggested part according to nominal information or the like, or could prove cost effective in being addressed at the same time the previously suggested part is addressed. For example, upon determining by the health prediction generator 430 that the brakes for automobile 460 have exceeded or are about to exceed a health threshold, the health prediction generator 430 can provide a suggestion to replace the brakes for automobile 460. In addition, the health prediction generator 430 could also analyze parts related to the brakes (e.g., rotors, calipers, etc.) and suggest replacement or maintenance if the related parts are at or near an associated health threshold. Accordingly, efficiencies in costs can be achieved by replacing additional parts at the same time because a mechanic will have already accessed an area within automobile 460 when replacing the previously suggested parts.

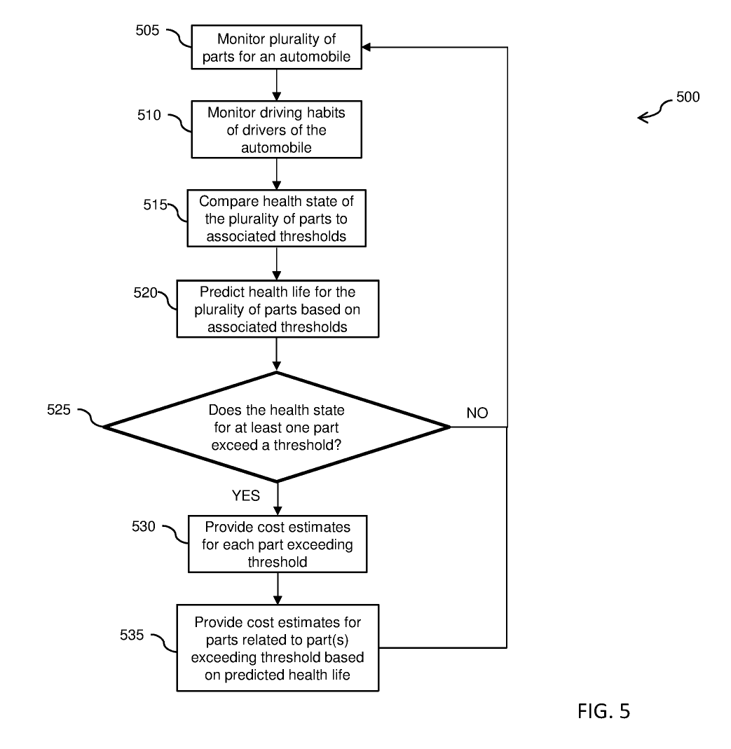

Now referring to FIG. 5, a flow diagram of a method 500 for monitoring a life cycle of one or more parts for an automobile and providing suggestions for maintenance of the automobile in accordance with one or more embodiments of the present invention. At block 505, a maintenance prediction engine can monitor a plurality of parts and systems of an automobile via use one or more sensors. For example, operation, wear and tear, or the like, for each of a plurality of parts related to the automobile may be monitored. At block 510, the maintenance prediction engine can monitor driving habits for one or more drivers associated with the automobile. For example, a driver may tend to speed resulting in hard braking. Accordingly, such hard braking may affect parts associated with stopping the automobile in a manner different from drivers that do not speed.

At block 515, a health state for each of the plurality of parts is compared to a health threshold associated with each of the plurality of parts. The health threshold for each of the parts can be based on nominal information. For example, tires can be recommended to be replaced after 40,000 miles. Accordingly, the mileage of the tires on the automobile would be compared to 40,000 miles (threshold). At block 520, a health life for each of the plurality of parts is predicted using the associated thresholds for each of the parts. For example, if the mileage for tires of the automobile are 30,000 and the tires have a threshold of 40,000 miles, the predicted life for the tires is 10,000 miles or 25%. The predicted health life can additionally be based on data associated with different automobiles, drivers, locations or the like (crowd sourced information).

At block 525, the maintenance prediction engine can determine whether any of the plurality of parts has exceeded an associated threshold. If none of the plurality of parts has exceeded a threshold, the method returns to block 505. If at least one of the plurality of parts has exceeded an associated threshold, the method proceeds to block 530, where cost estimates for repair, replacement and/or maintenance of the part(s) that has exceeded an associated threshold is determined. The cost estimates can be an average cost of repair, replacement and/or maintenance for part(s) based on a location or radius around a location associated one or more drivers of the automobile. The cost estimate information can be conveyed to the driver in a variety of manners. For example, after providing an alert to the driver, the part(s) exceeding the threshold, as well as the health state and cost estimate may be displayed on a console within the automobile or a display on a user device.

At block 535, cost estimates relating to repair, replacement, and/or maintenance of parts related to the part(s) that has exceeded an associated threshold is determined. For example, if the part(s) that has exceeded the threshold is a brake pad, the maintenance prediction engine can use nominal information to determine that rotors and calipers are related to brake pad replacement and determine costs estimates for the rotors and calipers based on the predicted health for the rotors and calipers.

Accordingly, a system, a method, and/or computer program product disclosed herein can predict a life cycle of vehicle parts based on the usage and driving habits and help users to be informed about parts that have exceeded or will soon exceed a manufacturer designed life cycle. Parts can be monitored using nominal information, user driving patterns and current driving conditions to predict and inform users about the life cycle of one or more parts, as well as an average cost of repairing, replacing or maintaining the parts that have exceeded or will soon exceed a manufacturer designed life cycle. The average cost can be associated with a location related to a driver or automobile. Additionally, an average cost of repairing, replacing, or maintaining parts related to parts that have exceeded or will soon exceed a manufacturer-designed life cycle may also be provided. The cost information for related parts can be used for more efficient maintenance of the automobile from a costs/and or time perspective because locations because a mechanic will have already accessed a portion of the vehicle to repair, replace or maintain parts related to parts that have exceeded or will soon exceed a manufacturer designed life cycle.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for monitoring a life cycle of one or more parts for an automobile and providing suggestions for maintenance of the automobile, the method comprising:
monitoring, using a processor, a plurality of parts of an automobile;
comparing, using the processor, a health state associated with each of the plurality of parts to a health threshold associated with each of the plurality of parts;
predicting, using the processor, a health life for each of the plurality of parts based on the comparison for each of the plurality of parts;
providing, using the processor, an alert to a driver in response to at least one part of the plurality of parts exceeding an associated health threshold; and
providing, using the processor, at least one cost estimate for repair, replacement or maintenance of the at least one part to the driver.

2. The computer-implemented method of claim 1, further comprising monitoring, using the processor, driving habits for one or more drivers associated with the automobile.

3. The computer-implemented method of claim 1, further comprising:
determining one or more parts related to the at least one part; and
providing at least one cost estimate for repair, replacement, or maintenance of the one or more parts to the driver.

4. The computer-implemented method of claim 3, wherein the determination that the one or more parts is related to the at least one part is based on nominal information.

5. The computer-implemented method of claim 1, wherein the at least one estimate is based on a location associated with the automobile.

6. The computer-implemented method of claim 1, further comprising using information associated with operation of the automobile, driving patterns of one or more drivers associated with the automobile, location information and weather information to determine patterns associated with the health life for each of the plurality of parts.

7. The computer-implemented method of claim 6, further comprising providing driving suggestions to extend a life cycle associated with the at least one part based on the determined patterns.

8. A computer program product, the computer program product comprising a computer readable storage medium having program instructions embodied therewith, the program instructions readable by a processing circuit to cause the processing circuit to:
monitor a plurality of parts of an automobile;
compare a health state associated with each of the plurality of parts to a health threshold associated with each of the plurality of parts;
predict a health life for each of the plurality of parts based on the comparison for each of the plurality of parts;
provide an alert to a driver in response to at least one part of the plurality of parts exceeding an associated health threshold; and
provide at least one cost estimate for repair, replacement or maintenance of the at least one part to the driver.

9. The computer program product of claim 8, further comprising using the processing circuit to monitor driving habits for one or more drivers associated with the automobile.

10. The computer program product of claim 8, further comprising using the processing circuit to:
determine one or more parts related to the at least one part; and
provide at least one cost estimate for repair, replacement, or maintenance of the one or more parts to the driver.

11. The computer program product of claim 10, wherein the determination that the one or more parts is related to the at least one part is based on nominal information.

12. The computer program product of claim 8, wherein the at least one estimate is based on a location associated with the automobile.

13. The computer program product of claim 8, further comprising using information associated with operation of the automobile, driving patterns of one or more drivers associated with the automobile, location information and weather information to determine patterns associated with the health life for each of the plurality of parts.

14. The computer program product of claim 13, further comprising using the processing circuit to provide driving suggestions to extend a life cycle associated with the at least one part based on the determined patterns.

15. A computer system, comprising:
a processor in communication with one or more types of memory, the processor configured to:
monitor a plurality of parts of an automobile;
compare a health state associated with each of the plurality of parts to a health threshold associated with each of the plurality of parts;
predict a health life for each of the plurality of parts based on the comparison for each of the plurality of parts;
provide an alert to a driver in response to at least one part of the plurality of parts exceeding an associated health threshold; and
provide at least one cost estimate for repair, replacement or maintenance of the at least one part to the driver.

16. The computer system of claim 15, wherein the processor is further configured to monitor driving habits for one or more drivers associated with the automobile.

17. The computer system of claim 15, wherein the processor is further configured to:
determine one or more parts related to the at least one part; and
provide at least one cost estimate for repair, replacement, or maintenance of the one or more parts to the driver.

18. The computer system of claim 17, wherein the determination that the one or more parts is related to the at least one part is based on nominal information.

19. The computer system of claim 15, wherein the processor is further configured to use information associated with operation of the automobile, driving patterns of one or more drivers associated with the automobile, location information and weather information to determine patterns associated with the health life for each of the plurality of parts.

20. The computer system of claim 19, wherein the processor is further configured to provide driving suggestions to extend a life cycle associated with the at least one part based on the determined patterns.
